(19) United States
(12) Patent Application Publication
(10) Pub. No.: US 2026/0202131 A1
(43) Pub. Date: Jul. 16, 2026

(54) DEVICE FOR COLOUR OPTIMISATION OF ACTIVATED CLAYS

(71) Applicants: thyssenkrupp Polysius GmbH, Beckum (DE); thyssenkrupp AG, Essen (DE)

(72) Inventors: Leo FIT, Muenster (DE); Christina PRIESEMANN, Apen (DE); Claudia BERGER, Schoenberg (DE)

(73) Assignees: thyssenkrupp Polysius GmbH, Beckum (DE); thyssenkrupp AG, Essen (DE)

(21) Appl. No.: 19/138,049

(22) PCT Filed: Dec. 7, 2023
(86) PCT No.: PCT/EP2023/084637

§ 371 Date: Jun. 11, 2025

(30) Foreign Application Priority Data
Dec. 14, 2022 (DE) 10 2022 133 349.3
Dec. 14, 2022 (LU) LU103050

(51) Int. Cl. F27B 1/00; C04B 7/42; C04B 7/43; C04B 7/45; C04B 103/00; F27B 15/09; F27B 15/10; F27B 15/18; F27B 19/04; F27D 19/00

(52) U.S. Cl. CPC F27B 1/005; C04B 7/42; C04B 7/434; C04B 7/45; F27B 15/09; F27B 15/10; F27B 15/18; F27B 19/04; C04B 2103/0096; F27D 2019/0003

(57) ABSTRACT

A device for the thermal activation of mineral materials comprises a calciner, a reduction device, and a material cooler, wherein the calciner and the reduction device are connected to one another for transfer of calcined material, wherein the reduction device is connected to the material cooler for transfer of color-optimized material, wherein the reduction device is a fluidized bed reactor.

The invention relates to a device and a method for the color optimization of activated clays.

The cement industry is a major carbon dioxide emitter. One important point is the carbon dioxide released from the limestone. Clinker substitutes, which preferably release no carbon monoxide at all during the activation, are resorted to in order to reduce the carbon dioxide emissions. Activated clays are therefore an important product. One problem with clays, however, is that they often contain for example iron, which is usually oxidized (at least partially) during activation under oxidizing conditions and is strongly red-coloring in the form Fe^{III}. However, this is usually not accepted by customers. In order to obtain a color resembling cement or clinker, which is accepted by customers, the activated clay is often treated under reducing conditions in order to reduce the oxidized iron again and therefore impart a color resembling cement to the activated clay.

DE 10 2016 104 738 A1 discloses a method and a device for the heat treatment of granular solids.

DE 10 2008 020 600 B4 discloses a method and a plant for the heat treatment of fine-grained mineral solids.

DE 10 2011 014 498 A1 discloses a clinker substitute.

US 2012/160 135 A1 discloses a method for the production of synthetic pozzolans.

WO 2021/224 055 A1 discloses a color optimization during the production of activated clays.

US 2014/0000491 A1 discloses a clinker substitute based on a calcined clay.

DE 10 2020 211 750 A1 discloses energy recovery during the cooling of color-optimized activated clays.

U.S. Pat. No. 4,573,908 A discloses a method and a device for the production of white cement clinker.

Two problems, however, are encountered in color optimization. On the one hand, a prolonged residence time of the already activated clays at high temperature is disadvantageous since it may lead to deactivation. This effect is also dependent on the particle size. With smaller particles, the deactivation occurs more rapidly. On the other hand, the reduction and therefore the color optimization are likewise dependent on the particle size. The smaller particles are, the more rapidly the decolorization takes place, while the larger particles are, the longer the time needed for the reduction is. Consequently, it is necessary to find an optimum at which the smallest particles are not deactivated but the largest particles are still decolorized. This optimum is achieved by selecting a particle size distribution which is as narrow as possible, that is to say the difference between the smallest particle and the largest particle is minimized. This is moreover costly and energy-intensive, which in turn creates a new possible source of carbon dioxide since renewable energy is only limitedly available for the processes for the production of a narrow grain range.

It is an object of the invention to provide a device and a method with which the color optimization is possible even with a significantly wider particle size distribution.

This object is achieved by a device having the features specified in claim 1. Advantageous developments may be found in the dependent claims, the following description and the drawings.

The device according to the invention is used for the thermal activation of mineral materials, in particular clays. The device comprises a calciner, a reduction device and a material cooler. The calciner and the reduction device are connected to one another via a first connection for the transfer of calcined material. The reduction device is connected to the material cooler via at least one second connection for the transfer of color-optimized material. According to the invention, the reduction device is a fluidized bed reactor. This fluidized bed reactor has been found to be extremely advantageous as a reduction device when there is a wide particle size distribution (a wide grain range). On the one hand, extremely small particles are extracted very rapidly with the fluidization gas. On the other hand, the particle size also has an influence on the transport velocity in the fluidized bed reactor. The fluidized bed reactor therefore allows the color optimization straightforwardly since small particles, which are color-optimized rapidly, are also extracted more rapidly, while large particles, which need a longer treatment time, also have longer residence time. It is therefore possible to save energy significantly in the size reduction and in the fractionation of the particle size distribution.

In addition, a preheater may for example be arranged upstream of the calciner. In this way, the heat extracted from the calciner with the gas flow is transferred to the material to be thermally activated.

According to the invention, the reduction device comprises a first material output and a second material output. In particular, the first material output and the second material output are arranged at different heights. For example, the first material output may be arranged on the lower side of the fluidized bed. In this way, a coarse fraction of the color-optimized material is extracted through the first material output. For example, the second material output may be arranged on the upper side of the fluidized bed. In this way, a fine coarse fraction of the color-optimized material is extracted through the second material output. Separation according to size may thus likewise take place besides the controlled color optimization. The two fractions may subsequently be further processed separately or in combination.

According to the invention, the reduction device comprises a gas outlet. The gas outlet is connected to a gas purification device, for example and preferentially a filter device, via a fourth connection. In the gas purification device, the finest fraction of the activated and color-optimized material is precipitated. This fraction is usually also the most active fraction. It may optionally be recombined with the further activated and color-optimized material. This finest fraction may, however, also be further processed separately, for example for particularly demanding applications.

According to the invention, the gas purification device comprises a solids outlet. The material cooler comprises at least a first inlet for material to be cooled, a second inlet for material to be cooled, an outlet for cooled material, a cooling gas inlet and a cooling gas outlet. The first inlet for material to be cooled is arranged fluidically closer than the second inlet for material to be cooled to the cooling gas inlet. The solids outlet is connected to the first inlet for material to be cooled via a third connection for the transfer of the material precipitated in the gas purification device. The first material output and/or the second material output is connected to the second inlet for material to be cooled via the second connection for the transfer of color-optimized material.

In this way, the fine material coming from the gas purification device comes in contact with the cooler cooling gas so that rapid cooling takes place in this case. This is advantageous since the fine fraction from the gas purification device is most susceptible to reoxidation and should therefore preferentially be cooled particularly rapidly.

The two fractions from the reduction device may either initially be combined and then supplied together to the material cooler through the second inlet for material to be cooled, or supplied separately through separate inlets for material to be cooled. It is, however, also possible for the material that is extracted from the material bed of the fluidized bed (medium fraction) to be joined with the fine material from the gas purification device before entry into the cooler.

In a further embodiment of the invention, the material cooler comprises a third inlet for material to be cooled. The first inlet for material to be cooled is arranged fluidically closer than the third inlet for material to be cooled to the cooling gas inlet. The second material output is connected to the third inlet for material to be cooled via a fifth connection for the transfer of color-optimized material. In this way, the medium fraction and the coarse fraction can be supplied separately, the third inlet for material to be cooled preferentially being arranged between the first inlet for material to be cooled and the second inlet for material to be cooled.

In a further embodiment of the invention, the first material output and the second material output are each connected to one another to the second inlet for material to be cooled of the material cooler for the transfer of color-optimized material. Further, the solids outlet of the gas purification device is connected to the first inlet for material to be cooled of the material cooler. Alternatively, the first material flow from the first material output and the second material flow from the second material output are introduced into the material cooler at different locations. In this way, adapted cooling may also take place, in particular when the first material flow and the second material flow have a different particle size distribution.

In a further embodiment of the invention, device comprises a disaggregation device. The disaggregation device is connected to the calciner for the transfer of disaggregated material. Preferentially, the disaggregation device is connected to the calciner via a preheater. For example and preferentially, the disaggregation device is connected via a flash dryer to the calciner for the transfer of disaggregated material. At least one preheater is preferentially arranged between the flash dryer and the calciner. Further preferentially, the disaggregation device is a hammer mill, vertical roller mill, impact mill, pendulum roller mill or agitator bead mill. Particular preferentially, the disaggregation device is a hammer mill.

In a further embodiment of the invention, the device comprises a color recording device. The color recording device is configured to record the color of the product. The color recording device is arranged in or along the product flow downstream of the material cooler. By recording the color, reduction and therefore color optimization can be carried out to the necessary extent but also restricted to the necessary extent, so that it is possible to save on reducing agent.

In a further embodiment of the invention, the device comprises a reducing agent supply. The reducing agent supply is connected to the reduction device for the delivery of reducing agent. Various gaseous, liquid or solid substances may be used as reducing agents. Typical gaseous reducing agents are methane, hydrogen or carbon monoxide. Examples of liquid reducing agents are liquid hydrocarbons. One important example of a solid reducing agent is coal, in particular pulverized coal, or biomass. If the reducing agent is a fuel, combustion usually takes place with an oxygen deficit so that a reducing atmosphere is created, for example and in particular carbon monoxide. The device further comprises a control device. The control device is configured to regulate the amount of reducing agent supplied by the reducing agent supply. For this purpose, the control device is correspondingly connected to the reducing agent supply for the transfer of control instructions or by the direct driving of, for example, servomotors. The control device is further configured to regulate the amount of reducing agent as a function of the color recorded by the color recording device. For this purpose, the control device has in particular a data connection to the color recording device in order to receive the product color recorded by the color recording device. Further, the control device has for example a color threshold value. If the color threshold value is exceeded, i.e. if the sample is for example too reddish, the supply of reducing agent is increased in order to achieve stronger decolorization. If the color threshold value is fallen below, the supply of reducing agent is reduced in order to avoid unnecessary consumption thereof. For example, the color threshold value may also be specified in the form of a range. Alternatively, the control device may have an allocation table in which the amount of reducing agent is specified for various color value ranges. Overall, it is therefore possible to use the minimum amount of reducing agent that is needed in order to achieve sufficient decolorization and therefore market acceptance.

It is possible to provide both a reducing agent and a fuel. For example, biomass is used as a fuel, for example with approximately stoichiometric combustion taking place. The residual oxygen content after the combustion is therefore usually low. Hydrogen, for example, is subsequently added as a reducing agent. As a small molecule, this has excellent diffusion properties but would be more expensive than biomass as a fuel.

In a further embodiment of the invention, a gas-sealing material lock is arranged between the reduction device and the material cooler.

In a further embodiment of the invention, a gas-sealing material lock is arranged between the calciner and the reduction device.

In a further embodiment of the invention, the device comprises a gas supply to the reduction device. The gas supply can be regulated in respect of volume flow rate and gas velocity. The device comprises a control device. The device further comprises a particle size specification device. The particle size specification device may, for example, be configured such that the particle size distribution is determined by a particle size measuring device and transmitted to the particle size specification device. Alternatively, the particle size specification device may be an input device in the conventional sense, with which an operator can enter the particle size distribution either directly or by selection from specified distributions. The particle size specification device may likewise be in the form of an interface to a central database system, which comprises for example data from laboratory analysis or concerning products to be delivered, and can thus transmit the particle size distribution for example on the basis of the material delivered. It is likewise possible that the particle size is recorded at least at two different positions, for example at a flash dryer and upstream of the fluidized bed reactor. Both items of information are transmitted together with the position data of the recording by the particle size specification device to the control device. The control device is configured to drive the gas supply in such a way that the control device controls the volume flow rate and gas velocity as a function of the particle size of the material, as specified by the particle size specification device. The particle size distribution has an influence on the minimum fluidization velocity (point of incipient fluidization), i.e. the point at which the gas flow just begins to fluidize the solid. Since the device is preferentially operated with a fluidization velocity of the gas flow that corresponds to from 5 times to 15 times the minimum fluidization velocity, it is helpful to record a quantity, for example the particle size, so that a modified minimum fluidization velocity of the fluidized bed can thereby readily be identified.

In a further embodiment of the invention, the particle size specification device comprises, or is connected to, a particle size measuring device. For example, the particle size measuring device may record the particle size and the particle size distribution by means of light scattering in or upstream of the calciner. Alternatively, samples may be taken upstream or downstream of the reduction device and supplied to the particle size measuring device.

In a further alternative embodiment of the invention, the particle size specification device is an input device via which the information can be entered manually by plant personnel. As a further alternative, the particle size specification device is an interface via which information relating to the particle size distribution may be received, for example from an analytical laboratory system.

In a further embodiment of the invention, the reduction device comprises deflector elements for guiding the material flow. For example, these may be arranged in the lower region of the fluidized bed in order to lengthen the path of the largest particles and thereby extend the residence time of these largest particles in the reduction device.

In a further embodiment of the invention, the reduction device comprises deflector elements for guiding the gas flow. This is used in particular to keep the gas flow that has already emerged from the fluidized bed, and the finest particles extracted with the gas flow, in the reduction device for a minimum time and thus ensure reliable reduction and color optimization. This may, for example, be done by labyrinth guiding.

In a further embodiment of the invention, a gas sensor is arranged fluidically downstream of the gas outlet, this gas sensor being configured to record the concentration of one or more substances selected from the list comprising carbon monoxide, carbon dioxide, hydrogen, methane. These substances may either be used directly as a reducing agent or formed in the reduction device. The concentration recorded at the output may therefore be used as an indicator of an excess of reducing agent. The carbon dioxide concentration is preferentially recorded together with the carbon monoxide concentration, particularly in order to determine the ratio.

In a further embodiment of the invention, the device comprises a bypass between the calciner and the material cooler for circumventing the reduction device. This bypass is preferentially used exclusively for the startup and shutdown of the device. Via the bypass, the activated material at the reduction device may be transferred directly into the material cooler.

In a further embodiment of the invention, the reduction device comprises a dip tube for the supply of activated material. The dip tube preferentially reaches into the fluidized bed. In this way, the activated material is introduced directly into the fluidized bed so that the residence time is extended somewhat, in particular for the finest particles, and color optimization is thus also ensured for the finest particles.

In a further aspect, the invention relates to a method for the color optimization of activated material with a device according to the invention. A wide particle size distribution is selected for the color optimization in the reduction device, the wide particle size distribution being distinguished in that at least 10 wt % of the particles are smaller than 50 μm and at least 10 wt % of the particles are larger than 250 μm. A wide grain range (particle size distribution) of this type is unusual and not processable by previous plants. In previous plants, the very small particles would already be deactivated before the very large particles are color-optimized. The use of a fluidized bed reactor, however, allows precisely the use of this wide particle size distribution. A great deal of energy may thus be saved in the size reduction, or disaggregation, and/or a size separation step may be obviated.

In a further embodiment of the invention, the particle size distribution is selected so that all the particles are smaller than 2 mm.

In a further embodiment of the invention, the particle size distribution is selected so that at least 5 wt % of the particles are larger than 900 μm.

In a further embodiment of the invention, the particle size distribution is selected so that at least 5 wt % of the particles are smaller than 20 μm.

In a further embodiment of the invention, at least 10 wt % of the material flow is extracted from the reduction device via the gas flow through the gas outlet and precipitated in the gas purification device. This means that the finest fraction having a particularly small particle size precisely makes up at least 10 wt %. By using a conventional method, this component would with a high probability lose activity again in the reduction device. In a fluidized bed reactor according to the invention, however, this fraction is extracted very rapidly via the fluidization gas so that although the color optimization takes place, deactivation does not. By this effect of the fluidized bed, separation of the finest fraction simultaneously takes place.

In a further embodiment of the invention, the fluidization velocity in the reduction device is selected in such a way that the fluidization velocity is from 5 times to 15 times the minimum fluidization velocity. The minimum fluidization velocity, or the point of incipient fluidization, is the flow velocity of the fluidization gas at which fluidization of the material sets in, i.e. the theoretically lowest velocity for formation of the fluidized bed. The different residence time of the particles as a function of size is significantly reinforced by this higher fluidization velocity, which means that precisely the finest particles, which are color-optimized very rapidly and which would also lose activity again correspondingly rapidly, are those that are also extracted again very rapidly with the gas, i.e. they have only a comparatively short residence time.

In a further embodiment of the invention, the fluidization gas has a temperature of at least 700° C. in the reduction device. For example and in particular, an off-gas having an oxygen component of less than 15 vol % may be used as the gas. The lower the oxygen content and the higher the temperature of the off-gas used are, the less it needs to be heated, so that less fuel (and therefore reducing agent) is needed. Preferentially, however, the off-gas has an oxygen component of more than 0.5 vol % in order to allow combustion and therefore release of energy. The process of the color optimization, for example the reduction of trivalent iron, is endothermic, so that the temperature would be lowered. In addition, the reduction device radiates heat. Particularly in order to be able to compensate for these two effects in the reduction device and not to allow cooling in the reduction equipment, the gas very preferentially has a corresponding residual oxygen content.

In a further embodiment of the invention, a reducing agent is introduced directly into the reduction device. For example, coal, in particular pulverized coal, or biomass may be introduced via a direct supply into the reduction device. In this way, on the one hand, a reducing atmosphere is generated directly in the fluidized bed, and, on the other hand, the heat is provided, likewise directly, by combustion and a constant temperature is thus maintained. Alternatively, for example, hydrogen or methane may be introduced directly into the reduction device.

In a further embodiment of the invention, a reducing agent is introduced with the gas flow into the reduction device. Above all, gaseous reducing agents such as hydrogen and methane, but also liquid reducing agents, for example liquid hydrocarbons, are suitable for this.

In a further embodiment of the invention, a reducing agent is introduced with the material flow into the reduction device. This is preferred for solid reducing agents, for example coal, in particular pulverized coal. In this case, reducing agent will already have been mixed with activated material before the introduction into the reduction device, so that a reducing atmosphere is provided in the same way for all particles from the start.

In a further embodiment of the invention, in the case of iron-containing minerals, in particular clays, having an Fe₂O₃ content of more than 20 wt %, reduction of the iron by at least 80% is carried out.

In a further embodiment of the invention, in the case of iron-containing minerals, in particular clays, having an Fe₂O₃ content of between 10 wt % and 20 wt %, reduction of the iron by 50 to 80% is carried out. The proportion of the iron component to be reduced is in this case increased from 50% at 10 wt % to 80% at 20 wt %. This may, for example, take place linearly or in stages.

In a further embodiment of the invention, in the case of iron-containing minerals, in particular clays having an Fe₂O₃ content of less than 10 wt %, reduction of the iron by up to 50% is carried out.

The device according to the invention is explained in more detail below with the aid of an exemplary embodiment, which is represented in the drawings.

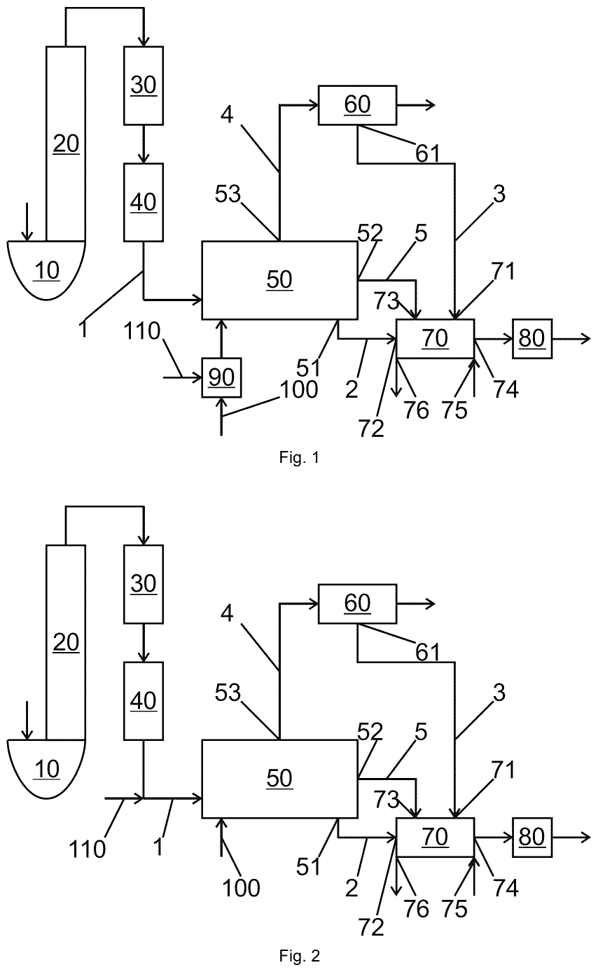

FIG. 1 first exemplary embodiment

FIG. 2 second exemplary embodiment

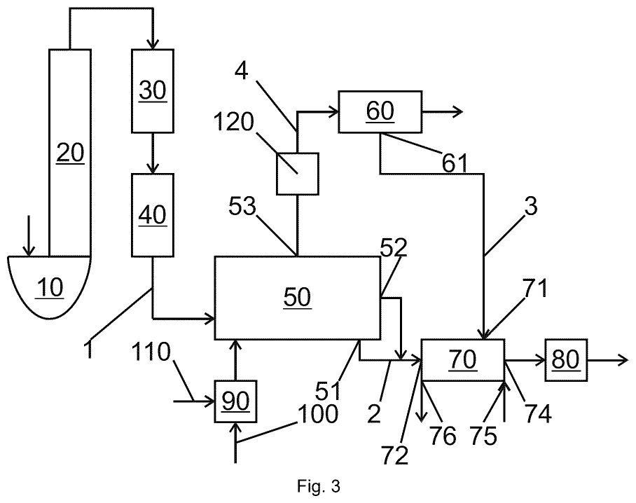

FIG. 3 third exemplary embodiment

FIG. 1 represents a first exemplary embodiment of a device according to the invention for the production of color-optimized activated material, in particular clays. The material initially enters a hammer mill 10, where it is disaggregated. This creates a comparatively wide particle size distribution. The disaggregated material is subsequently raised and dried in a flash dryer 20. The material subsequently passes via a preheater 30 into a calciner 40, where it is thermally activated. During the activation under oxidizing conditions, however, for example oxidation of iron to Fe^{III} also occurs, so that the material becomes reddishly discolored. The oxidation does not necessarily take place quantitatively, i.e. not all the iron atoms are necessarily oxidized to Fe^{III}. In order to reverse this, the thermally activated material is introduced via a first connection 1 into a fluidized bed reactor 50. For the fluidization of the fluidized bed, the fluidized bed reactor 50 is supplied with fluidization gas from a fluidization gas supply 100 via a combustion chamber 90, the combustion chamber 90 being supplied via a reducing agent supply 110, for example with pulverized coal in excess relative to the oxygen supplied with the fluidization gas, so that carbon monoxide is formed in the combustion chamber. The fluidization gas used may, for example, be oxygen-depleted off-gas from a process, for example from the preheater 30, or alternatively from the off-gas downstream of the gas purification device. The fluidized bed reactor 50 is, for example, operated in such a way that the fluidization velocity corresponds to from 5 times to 15 times the minimum fluidization velocity. The finest particles, which are most rapidly reduced and thereby color-optimized, are therefore extracted rapidly through the gas outlet 53 and pass through the gas outlet 53 and the subsequent fourth connection 4 into the gas purification device 60, in which they are then precipitated. The fluidized bed reactor 50 further comprises two outputs for the color-optimized material. The first material output 51 is arranged on the lower side and is used to remove the largest particles, while the second material output 52 is arranged in the upper region of the fluidized bed and is used to remove the medium particle fraction. All three fractions of the color-optimized material are supplied to a material cooler 70. For this purpose, the solids outlet 61 of the gas purification device 60 is connected via a third connection 3 to a first inlet 71 for material to be cooled. The first material output 51 is connected via a second connection 2 to the second inlet 72 for material to be cooled, and the second material output 52 is connected via a fifth connection 5 to the third inlet 73 for material to be cooled. Cooling gas is supplied to the material cooler 70 via the cooling gas inlet 75 and discharged via the cooling gas outlet 76. The cooled product may be removed via the outlet 74 for cooled material. The first inlet 71 for material to be cooled is in this case arranged closest to the cooling gas inlet 75, so that precisely the finest fraction is cooled most rapidly and thus protected best against reoxidation. Downstream of the cooling, the color is determined in the color recording device 80. In this way, the addition of reducing agent via the reducing agent supply 110 may be regulated so that as little reducing agent as possible is added but sufficient decolorization is nevertheless achieved.

FIG. 2 shows a second exemplary embodiment, which differs from the first exemplary embodiment shown in FIG. 1 in that the reducing agent is mixed with the activated material upstream of the fluidized bed reactor 50 and introduced together with it into the fluidized bed reactor 50. For example, pulverized coal is supplied via the reducing agent supply 110. In this way, the heat supply is also generated directly in the fluidized bed of the fluidized bed reactor 50 by combustion. This embodiment is preferred when the fluidization gas supplied by the fluidization gas supply 100 is already close to (just below) the ignition temperature of the reducing agent.

FIG. 3 shows a third exemplary embodiment, which differs from the first exemplary embodiment shown in FIG. 1 in that the fraction from the first material output 51 and the fraction from the second material output 52 are initially brought together and then supplied to the second inlet 72 for material to be cooled. A gas sensor 120 is arranged downstream of the gas outlet 53, so that besides the color recording in the color recording device 80, the reducing constituents still present in the off-gas may also be used as a process variable. The gas sensor 120 may, for example, be a carbon monoxide sensor. In addition, the finest material fraction is separated from the gas purification device 60. It often has the highest reactivity and may therefore be used for particularly high-grade products.

Reference Signs

| | |
|---|---|
| 1 | first connection |
| 2 | second connection |
| 3 | third connection |
| 4 | fourth connection |
| 5 | fifth connection |
| 10 | hammer mill |
| 20 | flash dryer |
| 30 | preheater |
| 40 | calciner |
| 50 | fluidized bed reactor |
| 51 | first material output |
| 52 | second material output |
| 53 | gas outlet |
| 60 | gas purification device |
| 61 | solids outlet |
| 70 | material cooler |
| 71 | first inlet for material to be cooled |
| 72 | second inlet for material to be cooled |
| 73 | third inlet for material to be cooled |
| 74 | outlet for cooled material |
| 75 | cooling gas inlet |
| 76 | cooling gas outlet |
| 80 | color recording device |
| 90 | combustion chamber |
| 100 | fluidization gas supply |
| 110 | reducing agent supply |
| 120 | gas sensor |

1-13. (canceled)

14. A device for thermal activation of mineral materials, comprising:
a calciner;
a reduction device; and
a material cooler;
wherein the calciner and the reduction device are connected to one another via a first connection for transfer of calcined material;
wherein the reduction device is connected to the material cooler at least via a second connection for transfer of color-optimized material;
wherein the reduction device is a fluidized bed reactor;
wherein the reduction device includes a first material output and a second material output;
wherein the first material output and the second material output are each connected to one another to the material cooler for transfer of color-optimized material;
wherein the reduction device includes a gas outlet connected to a gas purification device via a fourth connection;
wherein the gas purification device includes a solids outlet;
wherein the material cooler includes at least a first inlet for material to be cooled, a second inlet for material to be cooled, an outlet for cooled material, a cooling gas inlet and a cooling gas outlet;
wherein the first inlet for material to be cooled is arranged fluidically closer than the second inlet for material to be cooled to the cooling gas inlet;
wherein the solids outlet is connected to the first inlet for material to be cooled via a third connection for transfer of material precipitated in the gas purification device;
wherein the first material output and/or the second material output is connected to the second inlet for material to be cooled via the second connection for transfer of color-optimized material.

15. The device as claimed in claim 14, wherein the material cooler includes a third inlet for material to be cooled, wherein the first inlet for material to be cooled is arranged fluidically closer than the third inlet for material to be cooled the cooling gas inlet, wherein the second material output is connected to the third inlet for material to be cooled via a fifth connection for transfer of color-optimized material.

16. The device as claimed in claim 14, wherein the first material output and the second material output are each connected to the second inlet for material to be cooled of the material cooler, and the solids outlet of the gas purification device is connected to the first inlet for material to be cooled of the material cooler.

17. The device as claimed in claim 14, wherein the device includes a color recording device, wherein the color recording device is configured to record the color of the product, wherein the color recording device is arranged in or along the product flow downstream of the material cooler.

18. The device claim 17, wherein the device includes a reducing agent supply, wherein the reducing agent supply is connected to the reduction device for the delivery of reducing agent, wherein the device includes a control device, wherein the control device is configured to regulate the amount of reducing agent supplied by the reducing agent supply, wherein the control device is configured to regulate the amount of reducing agent as a function of the color recorded by the color recording device.

19. The device as claimed in claim 14, wherein a gas-sealing material lock is arranged between the reduction device and the material cooler.

20. The device as claimed in claim 14, wherein the device includes a gas supply to the reduction device, wherein the gas supply can be regulated in respect of volume flow rate and gas velocity, wherein the device includes a control device, wherein the control device is configured to drive the gas supply, wherein the control device controls the volume flow rate and gas velocity as a function of the particle size of the material.

21. The device as claimed in claim 14, wherein a gas sensor is arranged fluidically downstream of the gas outlet, wherein the gas sensor is configured to record the concentration of one or more substances selected from the list consisting of carbon monoxide, carbon dioxide, hydrogen, and methane.

22. A method for the color optimization of activated material with a device as claimed in claim 14, comprising:
selecting a wide particle size distribution for the color optimization in the reduction device, the wide particle size distribution being distinguished in that at least 10 wt % of the particles are smaller than 50 μm and at least 10 wt % of the particles are larger than 250 μm or at least 5 wt % of the particles are larger than 900 μm.

23. The method as claimed in claim 22, wherein at least 10 wt % of the material flow is extracted from the reduction device via the gas flow through the gas outlet and precipitated in the gas purification device.

24. The method as claimed in claim 22, wherein the fluidization velocity in the reduction device is selected so that the fluidization velocity is from 5 times to 15 times the minimum fluidization velocity.

25. The method as claimed in claim 22 wherein a reducing agent is introduced directly into the reduction device.

26. The method as claimed in claim 22, wherein a reducing agent is introduced with the gas flow into the reduction device.
